(19) United States
(12) Patent Application Publication
(10) Pub. No.: US 2006/0169799 A1
(43) Pub. Date: Aug. 3, 2006

(54) Low-volume nursery pot irrigation apparatus and method

(75) Inventors: Susan Stuart Thayer, Winter Haven, FL (US); Timothy Dean Wert, Lakeland, FL (US)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(73) Assignee: THAYER INDUSTRIES, INC.,

(21) Appl. No.: 11/325,266

(22) Filed: Jan. 3, 2006

Related U.S. Application Data
(63) Continuation of application No. 10/444,944, filed on May 23, 2003, now Pat. No. 7,004,403.

(51) Int. Cl. A62C 31/22

(52) U.S. Cl. 239/271

(57) ABSTRACT

An irrigation spray stake is for plants grown in pots. The irrigation spray stake includes an elongated stake member having an upper extremity and a lower extremity adapted to be inserted into soil in a plant pot. The irrigation spray stake further includes a spray head adjacent the upper extremity of the stake member and a means for spraying fluids through the spray head in a predetermined direction. A means along the stake member between the upper and lower extremities indicates the predetermined spraying direction of the spraying head.

### RELATED APPLICATION

This application is a continuation-in-part application of U.S. patent application Ser. No. 10/444,944 filed May 23, 2003, the entire subject matter of which is incorporated herein by reference.

### BACKGROUND OF THE INVENTION

1. Field of the Invention

The present invention relates generally to low-volume irrigation systems and techniques and, specifically to low-volume apparatus and methods useful for watering potted plants in a nursery, greenhouse, retail store or similar locations.

2. Description of the Background

There are numerous existing approaches to the irrigation of living plants. The term “low-volume irrigation” (sometimes referred to as “micro-irrigation”) is used in connection with a class of irrigation systems, apparatus and methods designed to apply a small quantity of water to an individual plant or a small number of immediately adjacent plants, usually at the base of the plant. One type of low-volume irrigation system uses a small spray head, referred to generically as a “microjet,” which is removably attached to the top of a stake pushed into the ground adjacent the base of the plant. Water is fed through the spray head via a length of flexible plastic tubing from the main feed line. In a typical low-volume installation such as in an orange grove, for example, there may be hundreds or even thousands of individual spray heads and associated tubing connected together in the irrigation system. Therefore, because the quantities of water in each feed line and through the corresponding spray head is small, the size and dimensions of these elements (e.g., spray head, stake and tubing) may also be correspondingly small and fabricated from inexpensive plastics.

There have been efforts in the past to apply low-volume irrigation techniques to the watering of plants being grown in movable pots, usually in a nursery, greenhouse, retail store or similar location where the plants are being maintained or grown for sale.

### SUMMARY OF THE INVENTION

The present invention is directed to irrigation apparatus and methods which can be used to provide low-volume irrigation to plants being grown in pots at a nursery, greenhouse, retail store or similar location in a low cost facile manner, and which can be rapidly and accurately installed in a pot to an appropriate soil depth and with the spray head oriented in the correct direction. In a preferred embodiment of the present invention, these objectives are achieved in a unitary spray stake having (a) a unitary molded spray head adjacent an upper extremity; (b) the spray head having a low-angle spray pattern which reduced overspray; (c) a directional feature along the length of the stake which permits the correct orientation of the spray head to be quickly identified during insertion; (d) a height indication feature which may be combined with the directional feature and which indicates the proper height of the stake in the pot; (e) a rotation-resisting feature for reducing rotation of the spray stake which may be combined with the directional and height indication features; (f a pot edge location feature which may be combined with the correct orientation and height features to permit the stake to be properly located relative to the edge of the pot; (g) a side shut-off arm along the portion of the stake which will be above the soil when the stake is in use to permit the end of the flexible tubing to be fitted in order to selectively interdict the flow of water; (h) a steep, two-step thread pattern on an inlet to the spray head and on the shut-off arm to permit tubing of different diameters to be repeatedly threaded onto the inlet and the arm in a rapid manner; (i) wide longitudinal ribs and notches along the length of the stake to insure the stake remains firmly in place when inserted in the pot soil; and (j) a steep end point for ease in placing the spray stake in the soil or alternatively into a (k) pot stake extender attachment for extending the length of the spray stake in accommodating tall pots.

### DESCRIPTION OF THE DRAWINGS

FIG. 1 is a perspective view of the preferred embodiment of the present invention.

FIG. 2 is a perspective view of the preferred embodiment of the present invention.

FIG. 3 is perspective view of the stake of FIG. 1 shown in a typical nursery pot installation with associated feed tubing, and with a portion of the nursery pot cut away.

FIG. 4 is a side view, partially cut away, illustrating the spray head portion of the stake of FIG. 1.

FIG. 5 is a perspective view of a pot stake extender in accordance with the present invention.

### DESCRIPTION OF THE PREFERRED EMBODIMENT

The present invention will now be described more fully hereinafter with reference to the accompanying drawings, in which preferred embodiments of the invention are shown. Unless otherwise defined, technical and scientific terms herein have the same meaning as commonly understood by one of ordinary skill in the art to which this invention pertains. Although methods and materials similar or equivalent to those described herein can be used in the practice or testing of the present invention, suitable methods and materials are described below. In addition, the materials, methods and examples given are illustrative in nature only and not intended to be limiting. Accordingly, this invention may be embodied in many different forms and should not be construed as limited to the illustrated embodiments set forth herein. Rather, these illustrated embodiments are provided solely for exemplary purposes so that this disclosure will be thorough and complete, and will convey the scope of the invention to those skilled in the art. Other features and advantages of the invention will be apparent from the following detailed description.

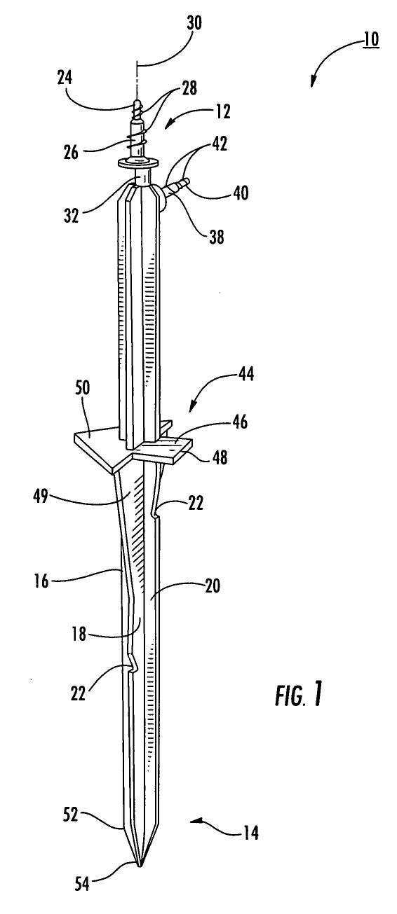

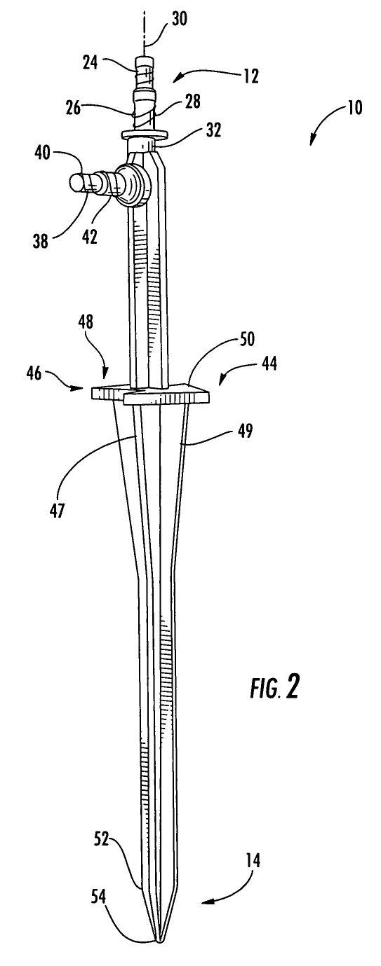

Referring now to FIGS. 1 and 2, a low-volume nursery pot irrigation stake in accordance with the present invention is referred to generally by the reference numeral 10. The stake 10 is formed of a unitary molded elongated member having an upper extremity 12, a lower extremity 14 and longitudinal ribs, including ribs 16, 18 and 20. One or more notches 22 along the ribs facilitate maintaining the stake firmly in the soil once installed. The stake 10 may be formed from any material appreciated by one of skill in the art. In an exemplary embodiment of the present invention, the stake 10 is formed from a durable ultraviolet inhibited resin material.

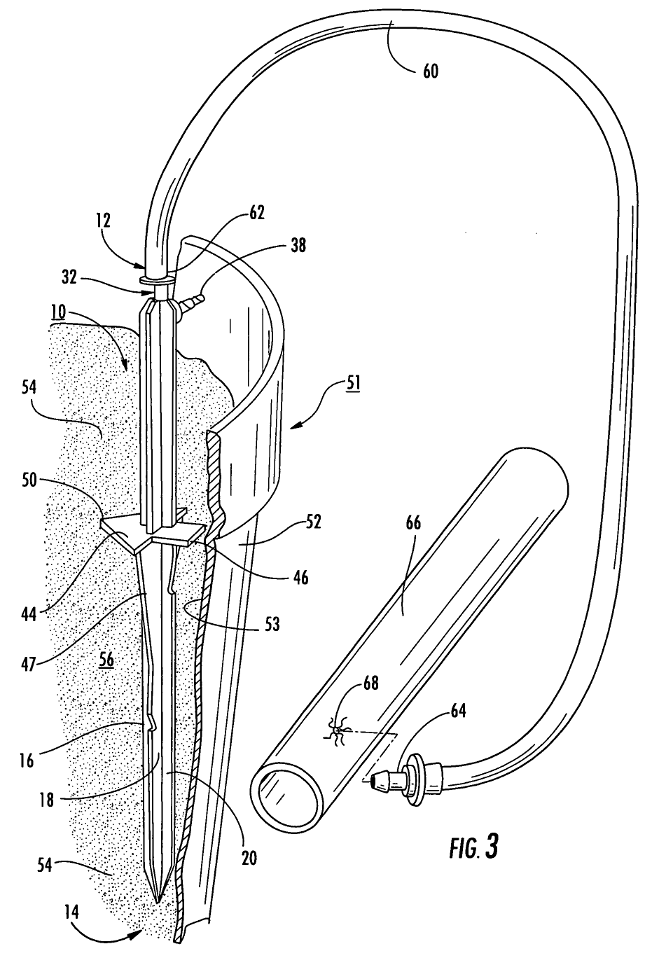

The stake 10 includes at the upper extremity 12 a two-step fitting for receiving feed tubing 60 (FIG. 3). Referring now to both FIGS. 1, 2 and 4, the two-step fitting comprises a first portion 24 of smaller cross-sectional dimension than a larger portion 26. Steep threads 28 surround both portions 24, 26. The respective portions 24, 26 have a corresponding initial portion 25, 27 (not shown), respectively, of slightly greater cross-sectional dimension to more firmly engage plastic tubing fitted thereon. The upper extremity 12 includes a central bore therethrough for permitting water to flow to a spray head 32, described below. The central bore is represented by dashed line 30 in FIGS. 1, 2 and 4.

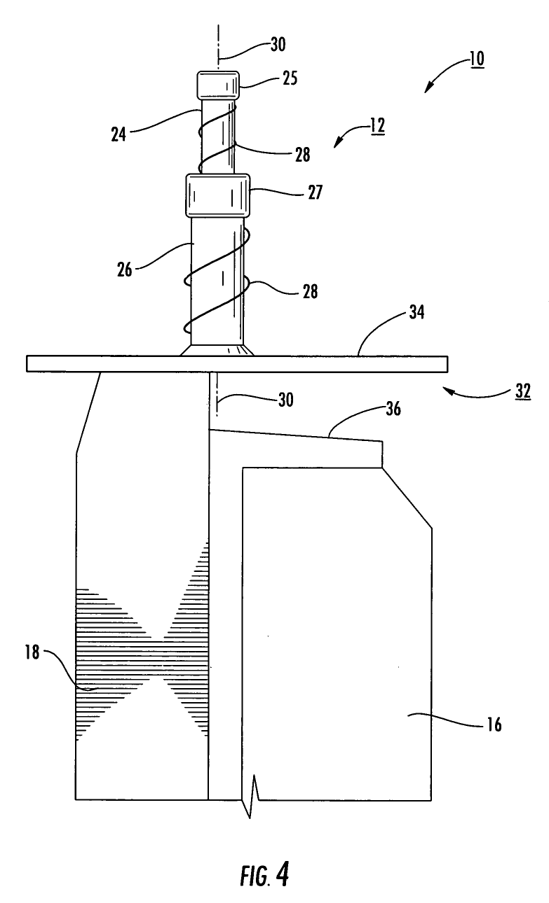

A spray head 32 is fitted on the stake 10 at the upper end 12 and in communication with the bore 30, so that water flowing through the upper end 12 exits into the spray head. With continued reference to FIG. 4, the spray head 32 includes an upper deflector plate 34 and a lower spray surface 36. As shown in FIG. 4, the spray surface 36 is angled slightly downwardly an outwardly from the central bore 30. The deflector plate 34 extends beyond the extremity of the spray surface 36, and assists in preventing overspray outside of the pot. The spray head 32 provides any number of preselected spray patterns, and may be designed for any desired flow rate.

Referring again to FIGS. 1 and 2, the stake 10 includes a side shut-off arm 38 which includes a two-step fitting like that described with reference to the upper end 12, the shut-off arm 38 having a smaller portion 40 and a larger portion 42. It will of course be understood that the shut-off arm 38 does not include a bore, in order that the arm may temporarily interdict the flow of water when the tubing 60 is fixed to the shut-off arm 38.

As described in the above summary, the preferred embodiment also includes means providing directional, height, rotation-resisting, and pot edge location features. In the preferred embodiment shown in the drawing, these features are achieved with a plate member, referred to generally with reference numeral 44, and which extends laterally from a mid-point along the stake 10. Preferably, the plate member 44 is molded together with the stake 10, although a separate plate member may also be snapped onto the stake as an alternative.

The plate member 44 has an upper surface 46 and opposing bottom surface (not numbered), a rear edge 48, a forward extremity 50, and opposing wings 47, 49. In the specific arrangement shown in FIGS. 1 and 2, the plate member 44 is shaped as an arrow pointing in the direction of spray from the spray head 32, with the forward extremity 50 forming the point of the arrow. In use, the plate member 44 serves at least four functions: first, the bottom of the plate member 44 identifies the correct soil depth to which the stake 10 should be extended into the soil contained in the pot; second, the rear edge 48 of the plate member 44 locates the correct distance from the inside periphery of the pot for correct placement of the stake 10; third, the direction of the arrow represented by extremity 50 is pointed in the same direction as the spray pattern of the spray head 32 and thereby permitting the correct direction of the spray pattern to be quickly identified; and fourth the wings 47, 49 extending laterally inward from the base of plate member 44 to ribs 18 so to inhibit rotation of stake 10 within the soil and provide lateral stability. It will of course be understood by those skilled in the art that other forms of the plate member 44 are quite possible; for example, the plate member may simply be a disk with a mark or arrow printed or molded onto the upper surface of the disk to indicate correct direction, with the lateral dimension of the disk indicating the correct position of the stake relative to the pot, the bottom of the disk serving to indicate correct soil height, and a longitudinal dimension to serve as wings 47, 49.

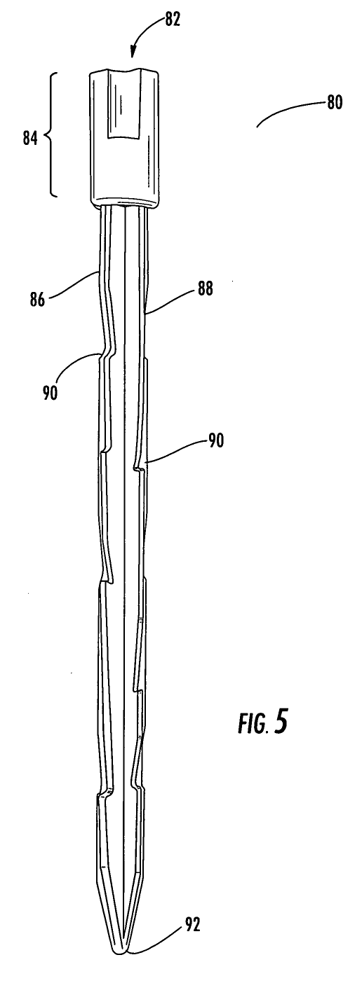

The bottom end 14 of the stake 10 includes a cross-sectional portion 52 below which ribs 16, 18, and 20 converge to an end point 54. End point 54 allows stake 10 to be easily inserted in various soil pots. Alternatively, end point 54 may be inserted into pot stake extender 80, illustrated in FIG. 5. Pot stake extender 80 includes a top aperture 82 and holding section 84 with a cross-sectional profile preferably accommodating the cross-section of stake 10 at portion 52 such that when end point 54 is inserted into aperture 82, stake 10 may be slid into holding section 84 of pot stake extender 80 and stake 10 securely extended. Pot stake extender 80 may be any length to accommodate an extension of stake 10. Pot stake extender 80 preferably includes ribs 86,88 having notches 90, as illustrated in FIG. 5. Pot stake extender 80 may also include an end point 92 similar to end point 54 of stake 10 for easy insertion into soil 10 and stability.

The manner in which the irrigation stake 10 in FIGS. 1 and 2 is utilized in a nursery pot installation will now be described with reference to FIG. 3. The stake 10 is inserted through the top surface 54 of the soil 56 contained within a nursery pot 51 having an outer, vertical surface 52 and a corresponding inner surface 53. Alternatively, stake 10 may be inserted into aperture 82 in which case stake 10 and pot stake extender 80 would collectively be so inserted. As shown, the stake 10 is installed with the bottom of the plate member 44 against the surface 54 of the soil 56, with the back edge 46 of the plate member 44 against the inside wall 53 of the pot 51 and wings 47, 49 extended perpendicular to the direction of spray head 32 to inhibit rotation of stake 10. By orienting the arrow 50 of the plate member 44 toward the middle of the pot 51, the installer can insure that the spray head 32 is accurately pointed toward the plant being grown in the pot 51.

Flexible plastic tubing 60 having an open end 62 is fitted onto the upper extremity 12 of the stake 10. A fitting 64 on the opposite end of the flexible tubing 60 is adapted to be inserted into a hole 68 in a main feed line 66, to provide water through the tube 60 and out of the spray head 32 in the direction of the plant located in the pot 51.

As discussed above, it will be appreciated by those skilled in the art that various modifications may be made in the design of the nursery pot irrigation stake and method described above, without departing from the spirit and scope of the present invention. By way of example and without limitation, the directional plate member 44 may be replaced by a directional clip which attaches to the stake 10 and to the plant pot, and which may also provide the heights and pot edge functions.

1. An irrigation spray stake for plants grown in pots, comprising:
an elongated stake member having an upper extremity and a lower extremity, the lower extremity converging at an end point to be inserted into soil in a plant pot;
a spray head adjacent the upper extremity of the stake member;
means for spraying fluids through the spray head in a predetermined direction;
means along the stake member between the upper and lower extremities which indicates the predetermined spraying direction of the spraying head; and
means along the stake member between the upper and lower extremities for resisting rotation of the elongated stake member while inserted into the soil.

2. The irrigation spray stake recited in claim 1 further comprising means between the upper and lower extremities of the stake member for indicating a desired height of the stake member above the soil after insertion into a pot.

3. The irrigation spray stake recited in claim 2 further comprising means between the upper and lower extremities of the stake member for locating a pot edge.

4. The irrigation spray stake recited in claim 3 wherein the direction indicating means comprises a plate member along and generally lateral to the direction of elongation of the stake member.

5. The irrigation spray stake recited in claim 4 wherein the plate member is integrally molded with the stake member.

6. The irrigation spray stake recited in claim 5 wherein the predetermined indicating means comprises an arrow molded with the plate member.

7. The irrigation spray stake recited in claim 6 wherein the height indicating means comprises a flat bottom surface of the plate member.

8. The irrigation spray stake recited in claim 7 wherein the pot edge locating means comprises a rear edge of the plate member.

9. The irrigation spray stake recited in claim 1 further comprising a shut-off arm along and extending laterally from the upper extremity of the stake.

10. The irrigation spray stake recited in claim 1 wherein the means for spraying fluids through the spray head comprises:
a fitting at the upper extremity of the stake member and extending generally in the direction of elongation of the stake member; and
a bore extending through the fitting and in communication with the spray head.

11. The irrigation spray stake recited in claim 10 further comprising a multiple-step thread pattern along the fitting for permitting tubing of different diameters to be repeatedly threaded thereon.

12. The irrigation spray stake recited in claim 1 further comprising longitudinal ribs and notches along the length of the stake to insure the stake remains firmly in place when inserted into soil of the pot.

13. The irrigation spray stake recited in claim 1, wherein the rotation-resistant means comprises opposing wings extending laterally inward from the direction indication means.

14. An irrigation stake, comprising:
an elongated member having an upper extremity and a lower extremity; a two-step fitting at the upper extremity comprising a first portion of smaller cross-sectional dimension and a larger portion of larger cross-sectional dimension, with the first and the larger portions each having threads and a corresponding initial portion of slightly greater cross-sectional dimension;
the lower extremity converging at an end point;
the upper extremity having a bore;
a spray head fitted on the elongated member at the upper extremity in fluid communication with the bore, the spray head having an upper deflector plate and a lower spray surface, the upper deflector plate extending beyond the extremity of the spray surface;
the elongated member having a plate member extending laterally from a point along the elongated member between the upper extremity and lower extremity, the plate member having an upper surface, an opposing bottom surface, a read edge, and a forward extremity;
the elongated member having at least one pair of opposing wings extending laterally inward from the plate member toward the lower extremity; and
a flexible tubing having an open end and an opposite end, the open end fitted onto the upper extremity, and the opposite end adapted for fluid communication with an irrigation fluid source.

15. The irrigation stake recited in claim 14, further comprising a side shut-off arm with a two step fitting having a smaller portion and a larger portion.

16. The irrigation stake recited in claim 14 wherein the spray head comprises means for selecting from a plurality of preset spray patterns.

17. The irrigation stake recited in claim 14, wherein the spray head comprises means for adjusting the spray flow rate.

18. The irrigation stake recited in claim 14, wherein the plate member is integrated into and an inseparable part of the elongated member.

19. The irrigation stake recited in claim 14, wherein the plate member includes a forward extremity for indicating the orientation of the spray head.

20. The irrigation stake recited in claim 14, wherein the plate member includes a rear edge dimensioned to permit proper and consistent positioning of the elongated member from a pot edge.

21. The irrigation stake recited in claim 14, wherein the spray head has alow-angle spray pattern to reduce over-spray.

22. The irrigation stake recited in claim 14, further comprising means for setting the insertion depth of the irrigation stake into soil.

23. A method of using the irrigation stake recited in claim 14, comprising the steps of:
(a) inserting the elongated member through the top surface of soil contained within a nursery pot, the nursery pot having an outer, vertical surface and a corresponding inner surface;
(b) pushing the elongated member downward into the soil until the bottom surface of the plate member rests against the surface of the soil, the pair of opposing wings achieve lateral stabilization within the soil and the back edge of the plate member rests against the inner surface of the nursery pot;
(c) orienting the elongated member with the forward extremity of the plate member toward the center of the nursery pot;
(d) attaching the open end of the flexible tubing onto the two-step fitting at the upper extremity of the elongated member;
(e) attaching the opposite end of the flexible tubing in fluid communication with an irrigating fluid source; and
(f) activating the irrigating fluid source to provide sufficient fluid pressure to dispense irrigating fluid through the spray head.

24. An irrigation spray stake for plants grown in pots, comprising:
a pot stake extender having an upper extremity and a lower extremity, the upper extremity including an aperture and lower extremity converging at an end point to be inserted into soil in a plant pot;
an elongated stake member having an upper extremity and a lower extremity, the lower extremity converging at an end point that is inserted into the aperture of the pot stake extender;
a spray head adjacent the upper extremity of the stake member;
means for spraying fluids through the spray head in a predetermined direction;
means along the stake member between the upper and lower extremities which indicates the predetermined spraying direction of the spraying head; and
means along the stake member between the upper and lower extremities for resisting rotation in the elongated stake member while inserted into the soil.
